(19) United States
(12) Patent Application Publication
(10) Pub. No.: US 2025/0368007 A1
(43) Pub. Date: Dec. 4, 2025

(54) REFRIGERANT CIRCULATING APPARATUS FOR VEHICLE

(71) Applicant: HANON SYSTEMS, Daejeon (KR)

(72) Inventors: In Keun KANG, Daejeon (KR); Hyeon Jun SHIN, Daejeon (KR); Tae Hyeong KIM, Daejeon (KR); Tea Gun LEE, Daejeon (KR); Seung Kyu OH, Daejeon (KR); Kyeong Cheol LEE, Daejeon (KR); Young Wook CHO, Daejeon (KR)

(21) Appl. No.: 19/225,507

(22) Filed: Jun. 2, 2025

(30) Foreign Application Priority Data
May 31, 2024 (KR) 10-2024-0071863
May 31, 2024 (KR) 10-2024-0071877

(51) Int. Cl. B60H 1/32

(52) U.S. Cl. CPC B60H 1/3228

(57) ABSTRACT

A refrigerant circulating apparatus for a vehicle according to an embodiment includes a refrigerant distribution unit in which a flow path through which a refrigerant flows is formed, one or more heat exchangers that are coupled to one surface of the refrigerant distribution unit and perform heat exchange with the refrigerant, and one or more valves that are coupled to the one surface of the refrigerant distribution unit and allow the refrigerant to selectively flow, wherein a refrigerant inlet/outlet through which the refrigerant is introduced or discharged is formed in the other surface of the refrigerant distribution unit.

### CROSS-REFERENCE TO RELATED APPLICATION

This application claims priority to and the benefit of Korean Patent Application No. 10-2024-0071863, filed on May 31, 2024 and Korean Patent Application No. 10-2024-0071877, filed on May 31, 2024, the disclosure of which is incorporated herein by reference in its entirety.

### BACKGROUND

### 1. Field of the Invention

The present invention relates to a refrigerant circulating apparatus for a vehicle, and more specifically, to a refrigerant circulating apparatus for a vehicle in which components such as a heat exchanger and valves are modularized into one unit.

### 2. Discussion of Related Art

Recent hybrid or electric vehicles are equipped with cooling devices to prevent a motor, electrical components, and batteries including fuel cells from overheating. In this case, an engine room includes pipes that connect a number of components, such as an air conditioning system for cooling and heating a vehicle interior, a cooling device, and a battery cooling device. Since these pipes have to connect a number of components, there is a problem in that a layout of the pipes becomes complicated.

Therefore, it is necessary to develop a refrigerant circulating apparatus for a vehicle that can be formed compactly by modularizing vehicle's major components (valves, an accumulator, a chiller, a condenser, an internal heat exchanger, sensors, and the like) and connecting pipes between the components.

### SUMMARY OF THE INVENTION

The present invention is directed to providing a refrigerant circulating apparatus for a vehicle, in which main components, such as a heat exchanger, valves, and sensors, are all disposed on one surface of a refrigerant distribution unit, and a pipe flange to which pipes are connected is disposed on a surface opposite to the one surface, thereby improving workability when a work such as replacing pipes is performed.

The present invention is also directed to providing a refrigerant circulating apparatus for a vehicle that minimizes thermal interference between refrigerants, prevents distortion or deformation when a first plate, an intermediate plate, and a second plate are coupled, and maintains rigidity of a structure by separating a first flow path through which a low-temperature refrigerant flows and a second flow path through which a high-temperature refrigerant flows and connecting the flow paths with a bridge portion.

The present invention is also directed to providing a refrigerant circulating apparatus for a vehicle in which a PT sensor is disposed at a point at which a first joining flow path and a second joining flow path join, and it is possible to accurately detect a refrigerant state when a refrigerant flows only in the first joining flow path, when a refrigerant flows only in the second joining flow path, and when refrigerants flow in both the first joining flow path and the second joining flow path.

According to an aspect of the present invention, there is provided a refrigerant circulating apparatus for a vehicle including a refrigerant distribution unit in which a flow path through which a refrigerant flows is formed, one or more heat exchangers that are coupled to one surface of the refrigerant distribution unit and perform heat exchange with the refrigerant, and one or more valves that are coupled to the one surface of the refrigerant distribution unit and allow the refrigerant to selectively flow, wherein a refrigerant inlet/outlet through which the refrigerant is introduced or discharged is formed in the other surface of the refrigerant distribution unit.

The refrigerant inlet/outlet may be provided with a pipe flange for coupling of a pipe.

A controller that controls the valves may be mounted on an upper portion of the refrigerant distribution unit in a direction perpendicular to the refrigerant distribution unit.

The heat exchanger and the valve may be disposed to face a vehicle body, and the refrigerant inlet/outlet may be disposed to face a power room.

A mounting wing for mounting the controller on the refrigerant distribution unit may be provided on a side surface of the controller.

The refrigerant circulating apparatus for a vehicle may further include one or more mounting brackets for mounting the refrigerant distribution unit on a vehicle body.

Some of the mounting brackets may have one end portion coupled to a vehicle body, and the other end portion coupled to both the refrigerant distribution unit and the controller.

A main connector may be provided on a front surface of the controller that faces a vehicle body, and a wire unit electrically connected to the valves may be connected to the main connector.

A sub-connector for electrical connection to an external power room component may be provided on a side surface of the controller.

A wire unit electrically connected to the valve may be connected to the controller, and the wire unit may be disposed on the one surface of the refrigerant distribution unit to which the heat exchanger and the valve are coupled.

A PT sensor that detects a pressure or temperature of the refrigerant may be coupled to the one surface of the refrigerant distribution unit.

According to another aspect of the present invention, there is provided a refrigerant circulating apparatus for a vehicle including a refrigerant distribution unit in which a plurality of flow paths through which a refrigerant flows are formed, and a PT sensor coupled to the refrigerant distribution unit and disposed downstream or at a point at which two or more flow paths join to detect a pressure or temperature of the refrigerant.

The PT sensor may be disposed at a point at which a first joining flow path and a second joining flow path formed in the refrigerant distribution unit join.

The first joining flow path and the second joining flow path may be disposed on a flow path through which a low-temperature refrigerant flows.

The first joining flow path may be a flow path through which a refrigerant heat-exchanged in a heat exchanger flows, the second joining flow path may be a flow path through which a refrigerant heat-exchanged in an evaporator flows, and the refrigerant joined in the first joining flow path and the second joining flow path may flow to an accumulator.

In a battery cooling mode, the refrigerant may flow only in the first joining flow path.

In a cooling or heating and dehumidification mode, the refrigerant may flow only in the second joining flow path.

In a cooling and battery cooling mode, the refrigerant may flow in the first joining flow path and the second joining flow path.

The refrigerant circulating apparatus for a vehicle may further include one or more heat exchangers that are coupled to one surface of the refrigerant distribution unit and perform heat exchange with the refrigerant, and one or more valves that are coupled to the one surface of the refrigerant distribution unit and allow the refrigerant to selectively flow, and a refrigerant inlet/outlet through which a refrigerant is introduced or discharged may be formed in the other surface of the refrigerant distribution unit.

The PT sensor may be coupled to the one surface of the refrigerant distribution unit to which the heat exchanger and the valve are coupled.

### BRIEF DESCRIPTION OF THE DRAWINGS

The and other objects, features and advantages of the present invention will become more apparent to those of ordinary skill in the art by describing exemplary embodiments thereof in detail with reference to the accompanying drawings, in which:

FIG. 1 is a perspective view illustrating a front surface of a refrigerant circulating apparatus for a vehicle according to an embodiment of the present invention;

FIG. 2 is a perspective view illustrating a rear surface of the refrigerant circulating apparatus for a vehicle according to the embodiment of the present invention;

FIG. 3 is a plan view illustrating the refrigerant circulating apparatus for a vehicle according to the embodiment of the present invention;

FIG. 4 is a side view illustrating the refrigerant circulating apparatus for a vehicle according to the embodiment of the present invention;

FIG. 5 is an exploded perspective view illustrating a refrigerant distribution unit of the refrigerant circulating apparatus for a vehicle according to the embodiment of the present invention;

FIG. 6 is a diagram illustrating a rear surface of the refrigerant distribution unit of the refrigerant circulating apparatus for a vehicle according to the embodiment of the present invention;

FIG. 7 is a diagram illustrating a mounting portion of a PT sensor in the refrigerant circulating apparatus for a vehicle according to the embodiment of the present invention;

FIG. 8 is a diagram illustrating a refrigerant flow path around the PT sensor according to a battery cooling mode;

FIG. 9 is a diagram illustrating a refrigerant flow path around a PT sensor according to a heating and dehumidification mode;

FIG. 10 is a diagram illustrating the refrigerant flow path around the PT sensor according to a cooling and battery cooling mode;

FIG. 11 is a diagram illustrating a refrigerant circulation in the battery cooling mode;

FIG. 12 is a diagram illustrating a refrigerant circulation in the heating and dehumidification mode; and

FIG. 13 is a diagram illustrating refrigerant circulation in the cooling and battery cooling mode.

### DETAILED DESCRIPTION OF EXEMPLARY EMBODIMENTS

The present invention can be modified in various ways and has various embodiments. Specific embodiments are illustrated in the accompanying drawings and will be described in detail. However, this is not intended to limit the present invention to the specific embodiments but should be understood to include all transformations, equivalents, or substitutes included in the spirit and technical scope of the present invention. In explaining the present invention, when it is determined that a detailed description of a related known technology may obscure the gist of the present invention, the detailed description thereof will be omitted.

The terms “first,” “second,” etc., may be used to describe various components, but the components should not be limited by the terms. The terms are used only to distinguish one component from another.

The terms used in this application are used only to describe particular embodiments and is not intended to limit the present invention. Singular expressions include plural expressions unless the context clearly indicates otherwise. It should be understood that the terms “include” and “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Additionally, throughout the specification, “connected” does not only mean that two or more components are directly connected, but can also mean that two or more components are indirectly connected through another component, that they are electrically connected as well as physically connected, or that they are integral although they are referred to by different names according to location or function.

Hereinafter, one embodiment of a vehicle thermal management fluid module according to the present invention will be described in detail with reference to the attached drawings. When explaining with reference to the attached drawings, identical or corresponding components are given the same reference numbers, and redundant descriptions thereof will be omitted.

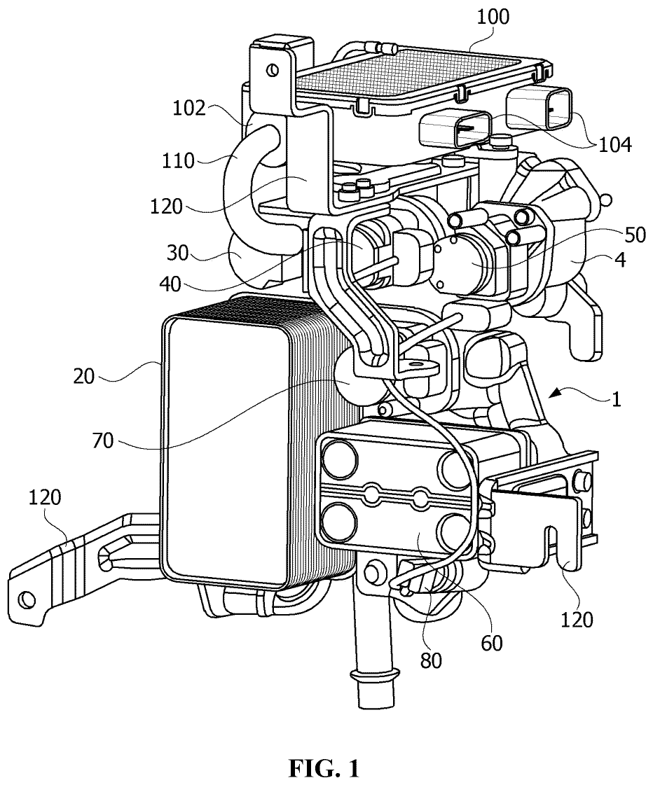

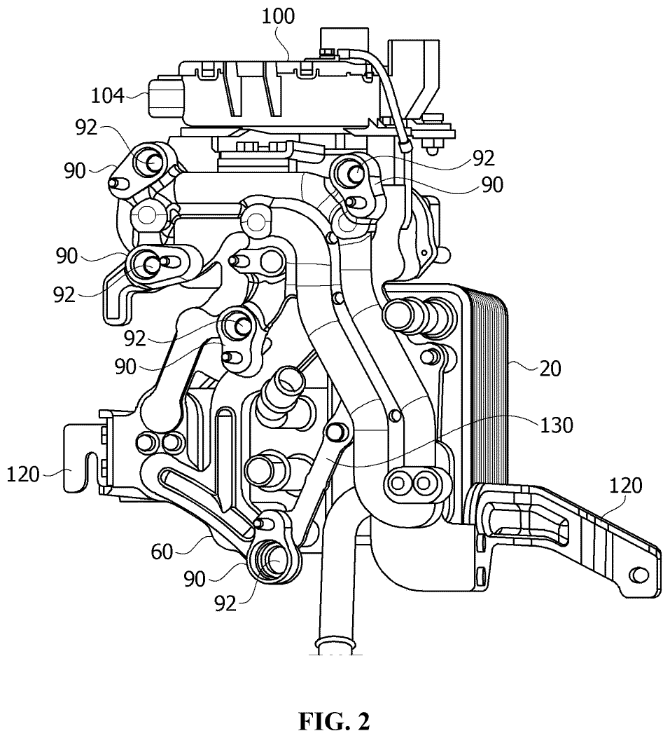

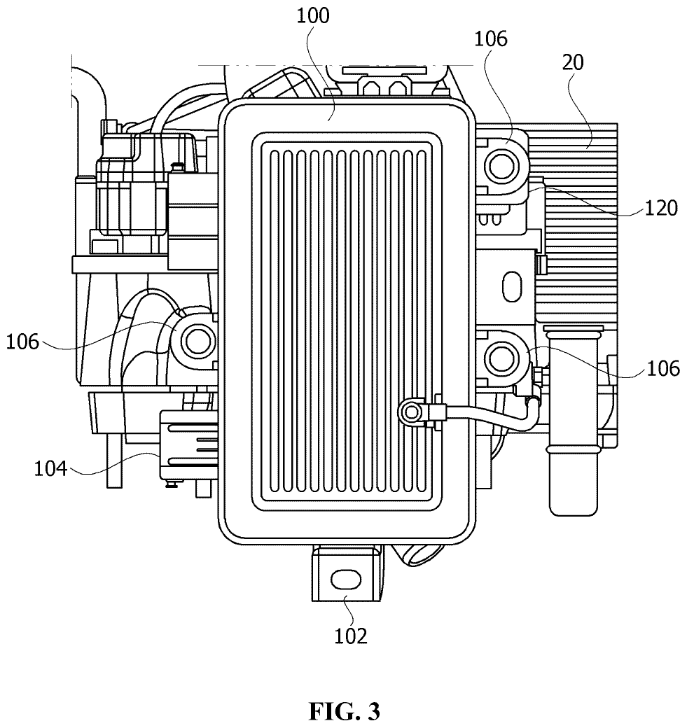

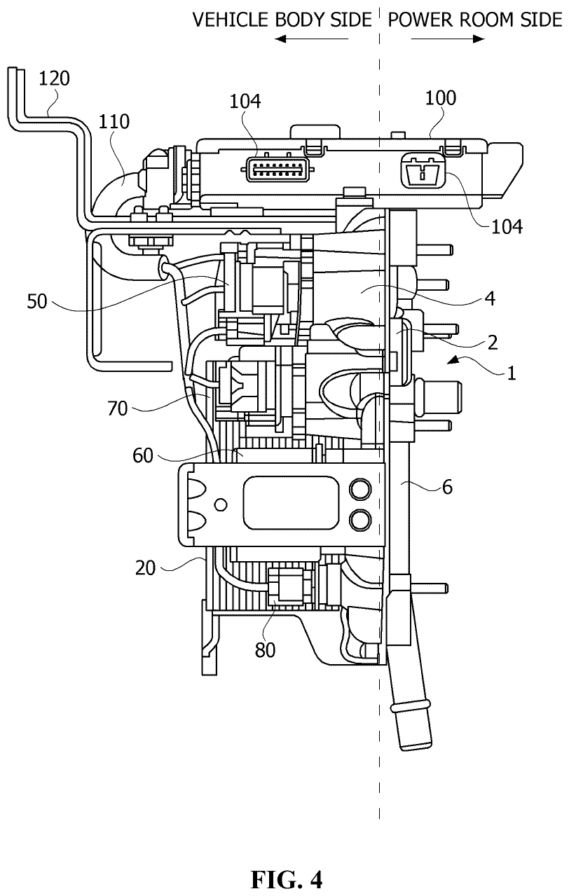

FIG. 1 is a perspective view illustrating a front surface of a refrigerant circulating apparatus for a vehicle according to an embodiment of the present invention, FIG. 2 is a perspective view illustrating a rear surface of the refrigerant circulating apparatus for a vehicle according to the embodiment of the present invention, FIG. 3 is a plan view illustrating the refrigerant circulating apparatus for a vehicle according to the embodiment of the present invention, and FIG. 4 is a side view illustrating the refrigerant circulating apparatus for a vehicle according to the embodiment of the present invention.

As illustrated, the refrigerant circulating apparatus for a vehicle according to the embodiment of the present invention includes a refrigerant distribution unit 1 in which a flow path through which a refrigerant flows is formed, one or more heat exchangers 20 and 60 that are coupled to one surface of the refrigerant distribution unit 1 and perform heat exchange with the refrigerant, and one or more valves 30, 40, 50, and 70 coupled to the one surface of the refrigerant distribution unit 1 and provided to allow the refrigerant to selectively flow. A refrigerant inlet/outlet 92 through which the refrigerant is introduced or discharged may be formed in the other surface of the refrigerant distribution unit 1.

The refrigerant distribution unit 1 has substantially a plate shape with a predetermined thickness and a refrigerant path formed therein. In this way, a first heat exchanger 20, a second heat exchanger 60, expansion valves 30 and 70, and direction changing valves 40 and 50, which are components of a heat exchange device of a thermal management system of a vehicle, are coupled and modularized in the refrigerant distribution unit 1, and thus a product manufacturing work is reduced and a work in a vehicle assembly line can also be reduced. In addition, the refrigerant distribution unit 1 performs functions of piping, fitting, and housing simultaneously, thereby reducing costs and improving workability. A specific configuration of the refrigerant distribution unit 1 will be described below.

Each of the first heat exchanger 20, the second heat exchanger 60, the first expansion valve 30, the first direction changing valve 40, the second direction changing valve 50, and the second expansion valve 70 may be coupled to the one surface of the refrigerant distribution unit 1. That is, main components such as the heat exchangers 20 and 60 and the valves 30, 40, 50, and 70 are all coupled to the one surface of the refrigerant distribution unit 1. The main components such as the heat exchangers 20 and 60 and the valves 30, 40, 50, and 70 may be coupled to a first plate 2 of the refrigerant distribution unit 1.

On the other hand, the refrigerant inlet/outlet 92 through which a refrigerant circulating through the refrigerant distribution unit 1 is introduced or discharged may be formed in the other surface of the refrigerant distribution unit 1. The refrigerant inlet/outlet 92 serves as a passage through which a refrigerant flows into the refrigerant distribution unit 1 via another pipe, or through which a refrigerant circulating through the refrigerant distribution unit 1 is discharged. In addition, a pipe flange 90 for coupling to a pipe may be provided to the refrigerant inlet/outlet 92. A pipe is coupled to the pipe flange 90, and a refrigerant may is introduced or discharged through the pipe.

A plurality of pipe flanges 90 may be disposed at various locations at the other surface of the refrigerant distribution unit 1. That is, the pipe flange 90 may be provided at each refrigerant inlet/outlet 92 through which a refrigerant flows into or out of the refrigerant distribution unit 1.

In this way, in the embodiment, the heat exchangers 20 and 60, the valves 30, 40, 50, and 70, and a PT sensor 80 which are the main components are all disposed on one surface of the refrigerant distribution unit 1, and the pipe flange 90 to which a pipe is connected is disposed on a surface opposite to the one surface. Therefore, workability can be improved when a work such as replacing pipes is performed.

Heat exchange may be performed in the first heat exchanger 20 and the second heat exchanger 60 through which a refrigerant and a coolant as heat exchange fluids pass. In the embodiment, a water-cooled condenser may be used as the first heat exchanger 20, and a battery chiller may be used as the second heat exchanger 60. The water-cooled condenser performs heat exchange of a high-temperature and high-pressure gaseous refrigerant, which is discharged from a compressor or an internal condenser, with an external heat to condense the refrigerant into a high-pressure liquid. The battery chiller is a device in which a low-temperature and low-pressure fluid is supplied and performs heat exchange with a coolant moving in a coolant circulation line (not shown). The cold coolant heat-exchanged in the battery chiller may circulate in the coolant circulation line and may perform exchange heat with the battery.

The first expansion valve 30 controls expansion of the refrigerant flowing into the first heat exchanger 20. The first expansion valve 30 may be disposed around the first heat exchanger and may expand or pass the refrigerant flowing into the refrigerant distribution unit 1. The refrigerant flowing in through the first expansion valve 30 may perform heat exchange while passing through the first heat exchanger 20 or may move to an external heat exchanger.

The refrigerant discharged through the first heat exchanger 20 flows into the first direction changing valve 40. The first direction changing valve 40 controls a flow direction of the refrigerant discharged from the first heat exchanger 20. The refrigerant flowing into the first direction changing valve 40 may move to an outdoor heat exchanger 140. In addition, the fluid flowing into the first expansion valve 30 may move to the second direction changing valve 50 in a dehumidification mode and then to an evaporator 160.

The second heat exchanger 60 is supplied with low-temperature and low-pressure refrigerant and performs heat exchange with the coolant moving in the coolant circulation line. The cold coolant heat-exchanged in the second heat exchanger 60 may circulate in the coolant circulation line and perform heat exchange with a battery 170. The refrigerant heat-exchanged with the outdoor heat exchanger 140 flows into the second expansion valve 70, and the refrigerant expanding in the second expansion valve 70 flows into the second heat exchanger 60. The refrigerant heat-exchanged in the second heat exchanger 60 is discharged through a lower end thereof and then flows into an accumulator 136.

In the embodiment, the first heat exchanger 20 and the second heat exchanger 60 may be disposed at the lower side of the one surface of the refrigerant distribution unit 1, and the expansion valves 30 and 70 and the direction changing valves 40 and 50 may be disposed at the upper side of the first heat exchanger 20 and the second heat exchanger 60. Of course, this is only an example of the heat exchangers 20 and 60 and the valves 30, 40, 50, and 70 and they may be disposed in other locations.

A PT sensor 80 that measures a temperature or pressure of the refrigerant may be disposed on a low-temperature flow path through which the refrigerant discharged from the second heat exchanger 60 flows. This is to sense an exact state (temperature and pressure) of the refrigerant discharged from the second heat exchanger 60 and improve controllability of the second expansion valve 70. The arrangement of the PT sensor 80 will be described in more detail below.

A controller 100 is an integrated driver for communicating the valves 30, 40, 50, and 70 and sensors (the PT sensor, and the like) of the refrigerant distribution unit 1 with an upper controller of a vehicle. The controller 100 is a part for controlling the valves 30, 40, 50, and 70 (the expansion valves, the direction changing valves, and the like) and sensors (the PT sensor) that have described above. The controller 100 may be formed in a substantially flat rectangular parallelepiped shape. Conventionally, the controller 100 was mounted between the refrigerant distribution unit 1 and a power room, but in the embodiment, the controller 100 is mounted on the refrigerant distribution unit 1 to facilitate after service processing. Here, the power room is apart in which a driving source is mounted. In the case of internal combustion engine vehicles, the power room is an engine room, and in the case of electric vehicles, it is a PE room.

The controller 100 may be detachably mounted on an upper end portion of the refrigerant distribution unit 1. The refrigerant distribution unit 1 is in the form of a manifold plate, and the one surface thereof is mounted on the power room. In the embodiment, the one surface on which the heat exchangers 20 and 60 and the valves 30, 40, 50, and 70 are disposed may be disposed upright to face the vehicle body side as in FIG. 4.

The controller 100 may be mounted on the upper end portion of the refrigerant distribution unit 1 in a vertical direction. The controller 100 is formed in a flat rectangular parallelepiped shape and may be mounted to be flat on the upper end portion of the refrigerant distribution unit 1 in a direction perpendicular to the refrigerant distribution unit 1. In this way, when the controller 100 is coupled to the upper end portion of the refrigerant distribution unit 1, there is an advantage in that the controller 100 can be easily serviced by simply separating the controller 100 from the refrigerant distribution unit 1 upon after service of the controller 100. In addition, in the above, the controller 100 is described as being mounted only on the upper end portion of the refrigerant distribution unit 1, but is not limited thereto, and the controller 100 may be mounted on a lower end portion or side surface of the refrigerant distribution unit 1 according to the convenience of after service.

A main connector 102 to which a wire unit 110 electrically connected to at least one of a valve and a sensor is connected is provided on a front surface of the controller 100. That is, the controller 100 may be connected to the valves 30, 40, 50, and 70 and the PT sensor 80, or may be connected to the valves 30, 40, 50, and 70 and the PT sensor 80 through the wire unit 110. In a direction in which the controller 100 is mounted, when a direction opposite to the power room is referred to as a forward direction, and a direction toward the power room is referred to as a rearward direction, the main connector 102 may be provided on the front surface as illustrated in FIG. 4. The controller 100 may be formed so that a length in a left-right direction is greater than a length in a front-rear direction, and the main connector 102 is provided on the front surface rather than on both side surfaces.

The main connector 102 may have a width in the front-rear direction smaller than a width of the refrigerant distribution unit 1 in the front-rear direction. That is, the main connector 102 may have a width in the front-rear direction that does not protrude outward further than the valves 30, 40, 50, and 70 and the PT sensor 80 disposed in the refrigerant distribution unit 1. When the main connector 102 has the width as described above, the main connector 102 does not protrude outward from the refrigerant distribution unit 1, and packaging of the refrigerant distribution unit 1 can be improved.

In the embodiment, the reason why the main connector 102 is disposed in this way is because interference between the wire unit 110 and the components (the heat exchangers, the valves, and the like) that are coupled to the refrigerant distribution unit 1 can be minimized and assemblability of the wire unit 110 can be improved by providing the main connector 102 on the front surface of the refrigerant distribution unit 1 rather than on the side surfaces or the rear surface of the refrigerant distribution unit 1 to which the heat exchangers and valves are coupled. That is, the main connector 102 may be disposed parallel to a direction in which the heat exchangers 20 and 60 and the valves 30, 40, 50, and 70 are coupled to the refrigerant distribution unit 1. Additionally, the controller 100 may be mounted on the refrigerant distribution unit 1 in which the overall length of the wire unit 110 is minimized.

The wire unit 110 has one end portion connected to the main connector 102, and may extend to the front side of the refrigerant distribution unit 1 so that the other end portion thereof is connected to the expansion valves 30 and 70 and the direction changing valves 40 and 50. In this case, since the wire unit 110 extends to the front side of the refrigerant distribution unit 1, interference with the expansion valves 30 and 70 and the direction changing valves 40 and 50 is minimized, and module integration is possible. In addition, the overall length of the wire unit 110 can be shortened to a shortest distance, and a layout can be simplified.

Meanwhile, a sub-connector 104 may be provided on a side surface of the controller 100. The sub-connector 104 is for electrical connection with external power room components and may be provided on a surface different from the main connector 102. The sub-connector 104 is preferably provided on the side surface of the controller 100 to facilitate connection with external power room components by an operator and may also be provided on the rear surface of the controller 100 or on the rear surface on which the main connector 102 is not provided.

A plurality of mounting wings 106 for mounting the controller 100 to the refrigerant distribution unit 1 may be provided on the side surface of the controller 100. The plurality of mounting wings 106 may be disposed on the side surface of the controller 100 and may be fastened to the refrigerant distribution unit 10 by fastening bolts or the like.

A mounting bracket 120 is coupled to the refrigerant distribution unit 1 to mount the refrigerant distribution unit 1 on the vehicle body. Referring to FIG. 1, in the embodiment, a total of three mounting brackets 120 may be mounted on the vehicle body in a state in which the mounting brackets 120 are coupled to the refrigerant distribution unit 1, but the present invention is not limited thereto, and four or more mounting brackets may be provided according to a mounting position of the refrigerant distribution unit 1.

A total of three mounting brackets 120, one at the upper side and one at each of opposite sides, may be coupled to the refrigerant distribution unit 1. Each of the mounting brackets 120 may be formed by bending a portion thereof to mount the refrigerant distribution unit 1 that is disposed upright to be mounted in the power room.

In the embodiment, among the mounting brackets 120, one end portion of the mounting bracket 120 coupled to the upper side may be coupled to the refrigerant distribution unit 1 as well as the mounting wings 106 provided on the controller 100. In one embodiment, at least some of the mounting wings 106 may be coupled not only to the refrigerant distribution unit 1, but also to the controller 100. In other words, some of the mounting brackets 120 are coupled only to the refrigerant distribution unit 1, others are coupled to the refrigerant distribution unit 1 and the controller 100, and thus the controller 100 can be mounted and supported together on the refrigerant distribution unit 1 and the controller 100 which are two components. Therefore, the controller 100 can be mounted more firmly compared to being mounted only on the refrigerant distribution unit 1.

Referring to FIG. 4, the main components (the heat exchangers, the valves, and the sensors) coupled to one surface of the refrigerant distribution unit 1 may be mounted on the vehicle body to face the vehicle body, and the pipe flange 90 provided on the other surface may be mounted on the vehicle body to face the power room. Due to such an arrangement, it is possible to easily couple and replace the pipes to/in the pipe flange 90.

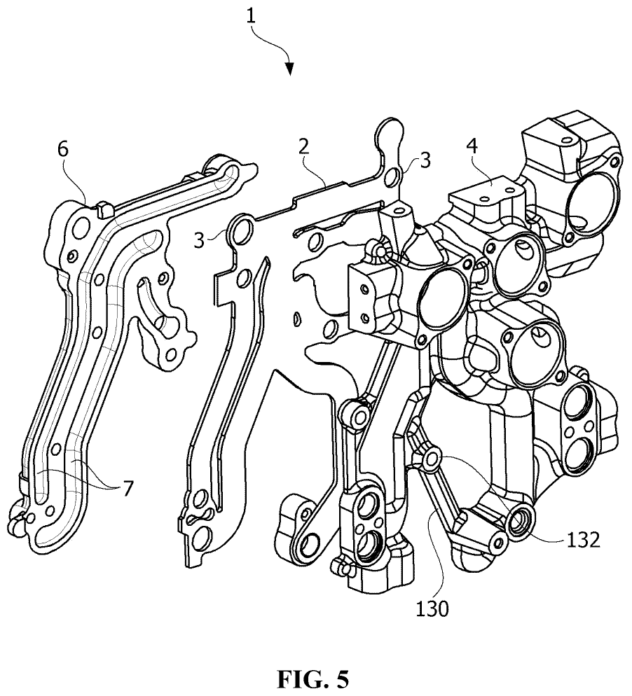

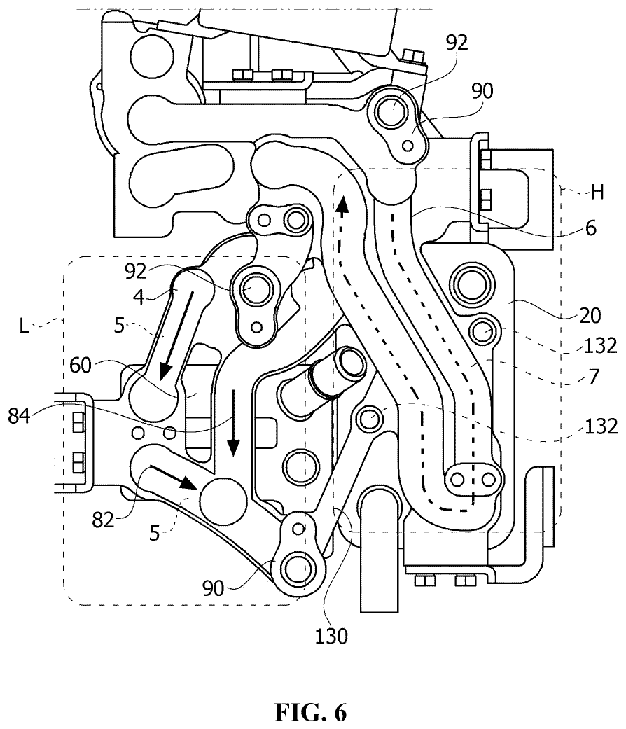

FIG. 5 is an exploded perspective view illustrating the refrigerant distribution unit of the refrigerant circulating apparatus for a vehicle according to the embodiment of the present invention, and FIG. 6 is a diagram illustrating the rear surface of the refrigerant distribution unit of the refrigerant circulating apparatus for a vehicle according to the embodiment of the present invention.

As illustrated, the refrigerant circulating apparatus for a vehicle according to the embodiment of the present invention may include the refrigerant distribution unit 1 in which a plurality of flow paths through which a refrigerant flows are formed, and the refrigerant distribution unit 1 may be provided with a bridge portion 130 that allows two of the plurality of flow paths to be connected without refrigerant communication.

Referring to FIG. 5, the refrigerant distribution unit 1 may include a intermediate plate 2, a first plate 4 coupled to one surface of the intermediate plate 2 and having a first flow path 5 formed therein through which a refrigerant flows, and a second plate 6 coupled to the other surface of the intermediate plate 2 and having a second flow path 7 formed therein through which a refrigerant flows.

Here, the intermediate plate 2, the first plate 4, and the second plate 6 may be manufactured by coupling them using brazing, structural adhesives, gaskets, and the like. Additionally, various materials such as aluminum, thermoplastic, stainless steel, and the like may be applied to the refrigerant distribution unit 1 according to manufacturing methods, and purposes and functions thereof.

The intermediate plate 2 is formed in a plate shape, the first plate 4 may be coupled to one surface of the intermediate plate 2, and the second plate 6 may be coupled to the other surface. The first plate 4 and the second plate 6 are coupled to protrude with a predetermined thickness to form refrigerant flow paths between the first plate 4 and the intermediate plate 2 and between the second plate 6 and the intermediate plate 2. According to the refrigerant distribution unit 1 formed by coupling, the heat exchangers, the valves, and the like can be coupled to the one surface of the intermediate plate 2, the refrigerant flow path can be formed, and modularization of components is possible in a more compact space.

The first flow path 5 through which a refrigerant flows may be formed inside the first plate 4, and the second flow path 7 through which a refrigerant flows may be formed inside the second plate 6. Accordingly, a flow of refrigerant is possible on the first plate 4 and the second plate 6 disposed on both sides of the intermediate plate 2.

A communication hole 3 for flow path communication between the valves connected to the first plate 4 and the second plate 6 may be formed in the intermediate plate 2. The communication hole 3 may be formed anywhere other than the portion illustrated in the drawing as long as it is a portion at which refrigerant flow paths between the valves are communicated with each other.

In one embodiment, the heat exchangers 20 and 60 and the valves 30, 40, 50, and 70 may be mounted on one surface of the first plate 4. In addition, the refrigerant inlet/outlet 92 may be formed in the second plate 6.

The refrigerant distribution unit 1 is divided into a high-temperature portion H through which a high-temperature refrigerant flows and a low-temperature portion L through which a low-temperature refrigerant flows, and the high-temperature portion H and the low-temperature portion L are formed to be spaced apart from each other. In one embodiment, in the refrigerant distribution unit 1, the high-temperature portion H and the low-temperature portion L may be formed as two legs that extend in two directions and are spaced apart from each other.

In the embodiment, a refrigerant flow path relatively corresponding to the low-temperature portion L may be formed in the first plate 4, and a refrigerant flow path relatively corresponding to the high-temperature portion H may be formed in the second plate 6. That is, a low-temperature refrigerant may mainly flow in the first flow path 5 of the first plate 4, and a high-temperature refrigerant may mainly flow in the second flow path 7 of the second plate 6.

In this way, thermal interference between the refrigerants can be minimized by forming the first flow path 5 in the first plate 4 to allow a low-temperature refrigerant to flow and forming the second flow path 7 on the second plate 6 to allow a high-temperature refrigerant to flow.

As described above, the high-temperature portion H and the low-temperature portion L are formed to be physically separated from each other, and the bridge portion 130 may be connected. The bridge portion 130 may be in the form of a rib that connects one side of the high-temperature portion H and one side of the low-temperature portion L, and since the refrigerant does not flow therein, the refrigerant flow paths are not communicated with each other. In one embodiment, the bridge portion 130 may be provided on the first plate 4 to connect the high-temperature portion H and the low-temperature portion L formed on the first plate 4.

To explain more specifically, the first flow path 5 formed on the surface that is coupled with the second plate 6 as described above is formed in the first plate 4, and a portion at which the first flow path 5 is formed may become the low-temperature portion L. Additionally, a portion of the first plate 4 at which the high-temperature portion H is formed may be coupled to the second plate 6 without forming the first flow path 5. In this case, since the high-temperature portion H and the low-temperature portion L formed on the first plate 4 extend in two branches in the form of legs, distortion or deformation may occur during a process of coupling (brazing) with the intermediate plate 2 and the second plate 6. When distortion or deformation occurs in the first plate 4 in this way, there is a risk of defects and leaks occurring when the intermediate plate 2 and the second plate 6 are coupled.

Therefore, in order to prevent this problem in the embodiment, the bridge portion 130 connecting the high-temperature portion H and the low-temperature portion L of the first plate 4 is formed on the first plate 4. That is, due to the bridge portion 130 being formed on the first plate 4, distortion or deformation can be prevented from occurring when the first plate 4, the intermediate plate 2, and the second plate 6 are coupled, and the rigidity of the structure can be maintained.

The bridge portion 130 provided on the first plate 4 described above is merely an example, and when the high-temperature portion H and the low-temperature portion L are formed together on the second plate 6, the bridge portion 130 may be formed on the second plate 6. In addition, when the high-temperature portion H and the low-temperature portion L are formed on each of the first plate 4 and the second plate 6, the bridge portion 130 may be provided on each of the first plate 4 and the second plate 6 so that the first plate 4 and the second plate 6 are coupled to each other.

In one embodiment, the bridge portion 130 may be disposed at various locations, such as connecting an end portion of the first flow path 5 and an end portion of the second flow path 7, connecting an end portion of the first flow path 5 and a middle portion of the second flow path 7, connecting a middle portion of the first flow path 5 and a middle portion of the second flow path 7, or connecting a middle portion of the first flow path 5 and an end portion of the second flow path 7.

Meanwhile, when the bridge portion 130 connects the first flow path 5 and the second flow path 7 in this way, the bridge portion 130, the first flow path 5, and the second flow path 7 may form a closed space.

In the above-described embodiment, when the high-temperature portion H and the low-temperature portion L are formed only on the first plate 4, since the second plate 6 may be coupled thereto after only the high-temperature portion H or the low-temperature portion L is formed on the second plate 6, a weight of a product can be reduced and manufacturing cost can be reduced.

Additionally, a heat exchanger connection hole 132 is formed in the bridge portion 130 for coupling of the first heat exchanger 20 mounted on the refrigerant distribution unit 1. The heat exchanger connection hole 132 is a portion that is fastened through a fastening hole on one side of the first heat exchanger 20 mounted on the refrigerant distribution unit 1. In this way, when the bridge portion 130 is additionally fastened to the first heat exchanger 20, the refrigerant distribution unit 1 and the first heat exchanger 20 can be coupled more firmly. Of course, the heat exchanger connection hole 132 for fastening with the first heat exchanger 20 may also be formed in the refrigerant distribution unit 1. In the above, the example in which the first heat exchanger 20 is fastened through the heat exchanger connection hole 132 has been described, but the second heat exchanger 60 may also be fastened through the heat exchanger connection hole 132.

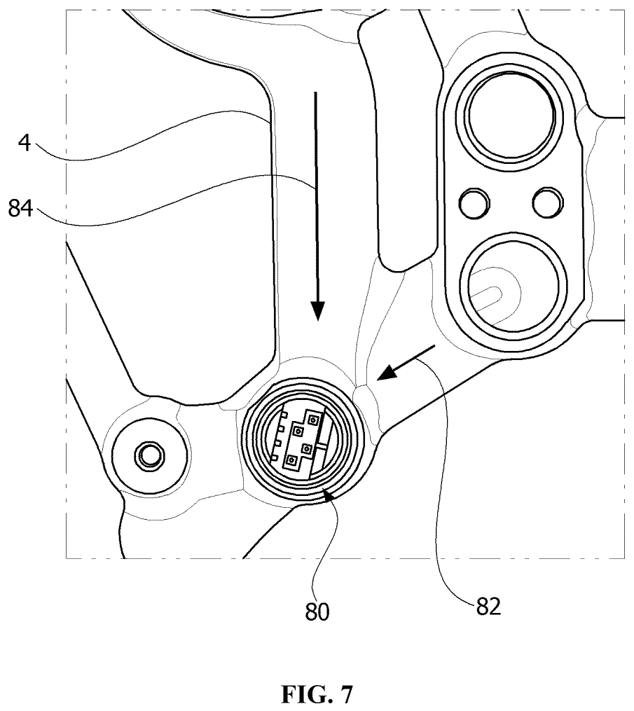

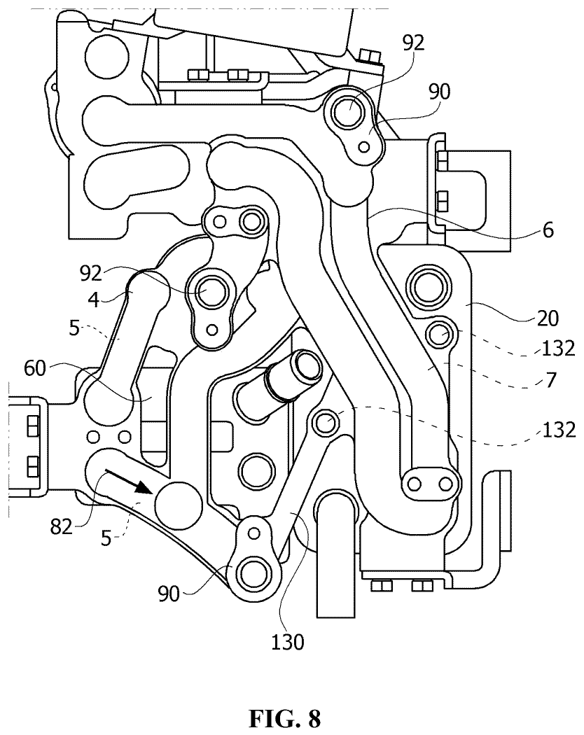

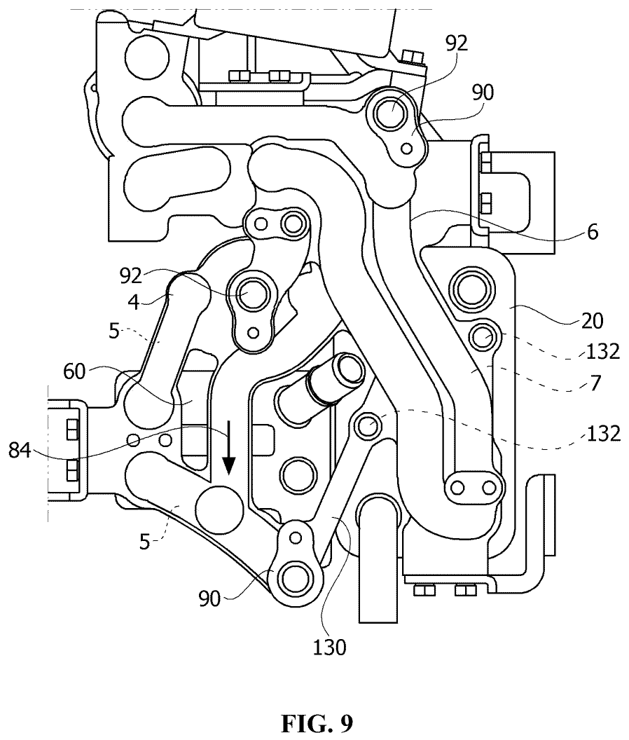

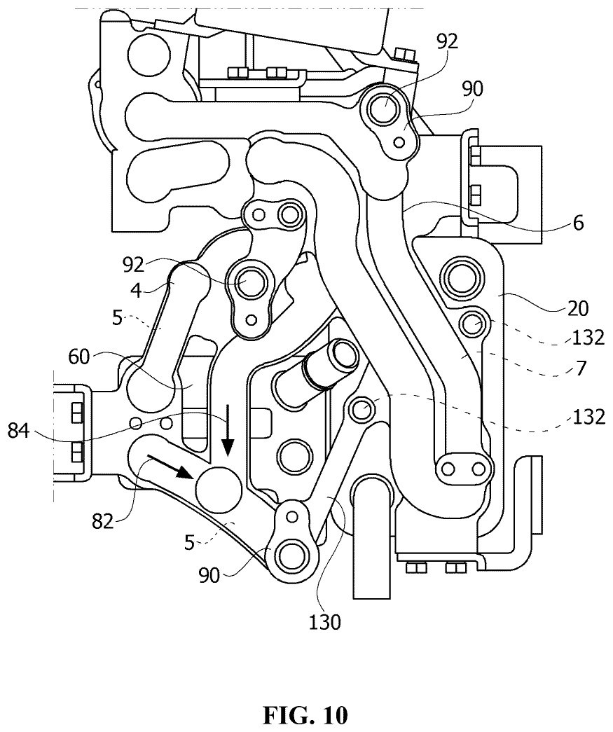

FIG. 7 is a diagram illustrating a mounting portion of the PT sensor of the refrigerant circulating apparatus for a vehicle according to the embodiment of the present invention, FIG. 8 is a diagram illustrating the refrigerant flow path around the PT sensor according to a heating mode, FIG. 9 is a diagram illustrating the refrigerant flow path around the PT sensor according to a heating and dehumidification mode, and FIG. 10 is a diagram illustrating the refrigerant flow path around the PT sensor according to a battery cooling mode.

As illustrated, the refrigerant circulating apparatus for a vehicle according to the embodiment of the present invention may include the refrigerant distribution unit 1 in which the plurality of flow paths through which a refrigerant flows are formed, and may include the PT sensor 80 coupled to the refrigerant distribution unit 1 and disposed downstream or at a point at which two or more refrigerant flow paths join to detect the pressure or temperature of the refrigerant.

The PT sensor 80 is mounted on the refrigerant flow path and detects the pressure or temperature of the refrigerant. The PT sensor 80 is coupled to the one surface of the refrigerant distribution unit 1, and in one embodiment, the PT sensor 80 may be coupled to the one surface of the first plate 4. That is, the PT sensor 80 may be mounted on the one surface of the first plate 4 as illustrated in FIG. 7.

The PT sensor 80 may be mounted on the one surface of the refrigerant distribution unit 1 together with the heat exchangers 20 and 60 and valves 30, 40, 50, and 70. Accordingly, as described above, since the pipe flange 90 to which the pipe is connected is disposed on the opposite surface, workability can be improved when a work such as replacing the pipe is performed.

In the embodiment, the PT sensor 80 may be mounted downstream or at a point at which the refrigerant flow paths join to easily detect a refrigerant state. In one embodiment, the PT sensor 80 may be mounted at a joining point at which the refrigerant flow paths change according to air conditioning modes. The PT sensor 80 may be disposed at a point at which the first joining flow path 82 and the second joining flow path 84 join. Here, the reason why the PT sensor 80 is disposed at the point at which the first joining flow path 82 and the second joining flow path 84 join is because sensing ability to detect the refrigerant state decreases when the PT sensor 80 is disposed upstream from the joining point.

In other words, in the case that the PT sensor 80 is disposed at the point in which the first joining flow path 82 and the second joining flow path 84 join, it is possible to accurately detect the refrigerant state when the refrigerant flows only in the first joining flow path 82, when the refrigerant flows only in the second joining flow path 84, and when the refrigerant flows in both of the first joining flow path 82 and the second joining flow path 84.

In one embodiment, the first joining flow path 82 may be a flow path through which the refrigerant heat-exchanged in the second heat exchanger 60 flows. In one embodiment, the second joining flow path 84 may be a flow path through which the refrigerant heat-exchanged in the evaporator 160 flows.

Referring to FIG. 8, in the battery cooling mode, a refrigerant heat-exchanged in the second heat exchanger 60 may flow only in the first joining flow path 82, and the refrigerant may not flow in the second joining flow path 84. In this case, the PT sensor 80 may detect the exact pressure or temperature of the refrigerant flowing only in the first joining flow path 82.

Referring to FIG. 9, in the heating and dehumidification mode, the refrigerant heat-exchanged in the evaporator 160 may flow only in the second joining flow path 84, and the refrigerant may not flow in the first joining flow path 82. In this case, the PT sensor 80 can detect the exact pressure or temperature of the refrigerant flowing only in the second joining flow path 84.

Referring to FIG. 10, a refrigerant may flow in both the first joining flow path 82 and the second joining flow path 84 in the cooling and battery cooling mode. In this case, the PT sensor 80 can detect the exact pressure or temperature of the refrigerant joining along the first joining flow path 82 and the second joining flow path 84.

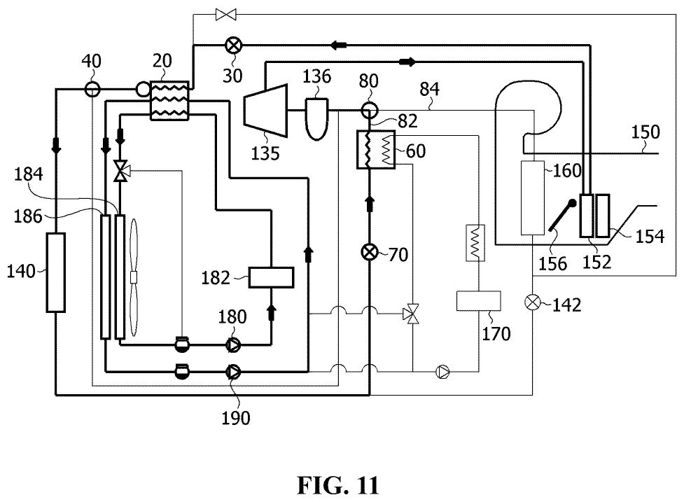

FIG. 11 is a diagram illustrating refrigerant circulation in the battery cooling mode.

Referring to FIG. 11, a compressor 135 is operated, and a high-temperature and high-pressure refrigerant is discharged from the compressor 135. The refrigerant discharged from the compressor 135 passes through the indoor heat exchanger 152 and the first expansion valve 30 in a non-expanded state.

The refrigerant passing through the first expansion valve 30 is condensed through heat exchange with the coolant while passing through the first heat exchanger 20. Then, the refrigerant passing through the first direction changing valve 40 flows into the outdoor heat exchanger 140 and performs heat exchange with the outside air.

The refrigerant discharged from the outdoor heat exchanger 140 expands in the second expansion valve 70 and then flows into the second heat exchanger 60 to perform heat exchange with the coolant. The refrigerant heat-exchanged in the second heat exchanger 60 passes through the accumulator 136 and flows back into the compressor 135.

Meanwhile, the coolant in a first coolant circulation line among coolant lines is circulated by an operation of a water pump 190. The circulating coolant performs heat exchange while passing through the first heat exchanger 20 and a radiator 184, and thus cooling of an electrical component module 182 is achieved. The coolant in a second coolant circulation line, which is another line among the coolant lines, is circulated by the operation of the water pump 190. The circulating coolant performs heat exchange while passing through the first heat exchanger 20 and the radiator 186.

Meanwhile, the refrigerant heat-exchanged in the second heat exchanger 60 may flow only in the first joining flow path 82 and may not flow in the second joining flow path 84. In this case, the PT sensor 80 may detect the exact pressure or temperature of the refrigerant flowing only in the first joining flow path 82.

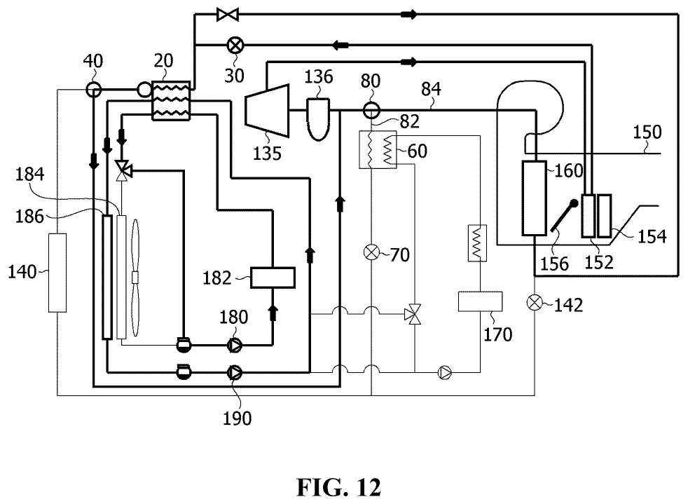

FIG. 12 is a diagram illustrating the refrigerant circulation in the heating and dehumidification mode.

Referring to FIG. 12, the compressor 135 is operated, and a high-temperature and high-pressure refrigerant is discharged from the compressor 135. The refrigerant discharged from the compressor 135 performs heat exchange with air flowing through an air conditioning case 150 while passing through the indoor heat exchanger 152, and air heated by a PTC heater 154 is supplied as warm air into the vehicle interior to perform heating.

The refrigerant passing through the indoor heat exchanger 152 expands while passing through the first expansion valve 30, and the refrigerant passing through the first expansion valve is condensed through heat exchange with the coolant while passing through the first heat exchanger 20. Additionally, in the first direction changing valve 40, the outdoor heat exchanger 140 is blocked and the accumulator 136 is opened. Accordingly, the refrigerant may flow from the first heat exchanger 20 through the accumulator 136 and then flow back into the compressor 135.

Meanwhile, the coolant in the first coolant circulation line among the coolant lines is circulated by the operation of the water pump 190. The circulating coolant performs heat exchange while passing through the first heat exchanger 20 and the radiator 184, and thus cooling of the electrical component module 182 is achieved. The coolant in the second coolant circulation line, which is another line among the coolant lines, is circulated by the operation of the water pump 190. The circulating coolant performs heat exchange while passing through the first heat exchanger 20 and the radiator 186.

In addition, in the heating and dehumidification mode, some of the refrigerant passing through the first expansion valve 30 flows into the evaporator 160 through a separate line and performs heat exchange. The low-pressure and low-temperature refrigerant flowing into the evaporator 160 performs heat exchange with air blown into the vehicle interior, thereby removing moisture in the air.

Meanwhile, the refrigerant heat-exchanged in the evaporator 160 may flow only in the second joining flow path 84 and the refrigerant may not flow in the first joining flow path 82. In this case, the PT sensor 80 can detect the exact pressure or temperature of the refrigerant flowing only in the second joining flow path 84.

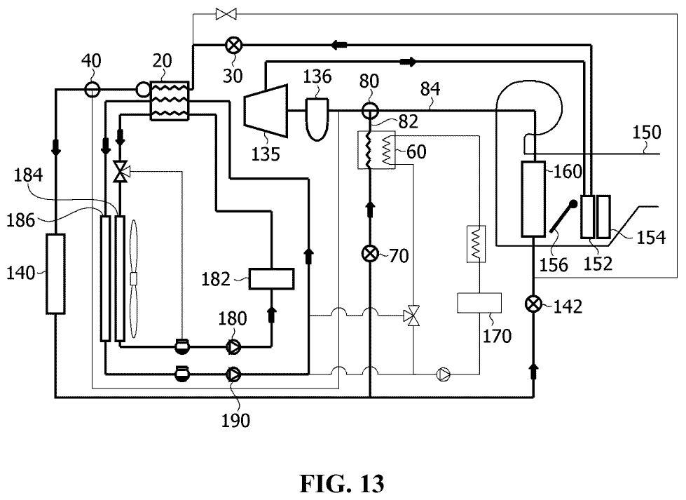

FIG. 13 is a diagram illustrating the refrigerant circulation in the cooling and battery cooling mode.

Referring to FIG. 13, in the cooling mode, the same refrigerant and cooling water circulation occurs as in the battery cooling mode illustrated in FIG. 11. In cooling mode, some of the refrigerant passing through the outdoor heat exchanger 140 expands in the third expansion valve 142 and then flows into the evaporator 160 for heat exchange. The refrigerant heat-exchanged in the evaporator 160 performs heat exchange with air flowing through the air conditioning case 150, and as the refrigerant evaporates, the air is cooled, and the cooled air is supplied to the vehicle interior, thereby cooling the interior of the vehicle.

The refrigerant heat-exchanged in the evaporator 160 passes through the accumulator 136 and then flows back into the compressor 135. A temperature control door 156 may be mounted between the evaporator 160 and the indoor heat exchanger 152 inside the air conditioning case 150 to control an amount of air bypassing the indoor heat exchanger 152 and an amount of air passing through the indoor heat exchanger 152.

Meanwhile, the refrigerant may flow in both the first joining flow path 82 and the second joining flow path 84. The PT sensor 80 can detect the exact pressure or temperature of the refrigerant joining along the first joining flow path 82 and the second joining flow path 84.

The three modes described above are presented as examples of the refrigerant circulation flowing through the first joining flow path 82 and/or the second joining flow path 84, and are not limited thereto, and can be applied to other air conditioning modes as well. For example, even in the cooling mode, the refrigerant heat-exchanged in the evaporator 160 may flow only in the second joining flow path 84, and the refrigerant may not flow in the first joining flow path 82. In this case, the PT sensor 80 can detect the exact pressure or temperature of the refrigerant flowing only in the second joining flow path 84.

According to one embodiment of the present invention, since the main components, such as a heat exchanger, valves, and sensors, are all disposed at one surface of a refrigerant distribution unit, and a pipe flange to which pipes are connected is disposed on a surface opposite to the one surface, workability can be improved when a work such as replacing pipes is performed.

Further, according to one embodiment of the present invention, by separating a first flow path through which a low-temperature refrigerant flows and a second flow path through which a high-temperature refrigerant flows and connecting the flow paths with a bridge portion, thermal interference between the refrigerants can be minimized, distortion or deformation can be prevented from occurring when a first plate, an intermediate plate, and a second plate are coupled, and rigidity of a structure can be maintained.

Furthermore, according to one embodiment of the present invention, a PT sensor is disposed at a point at which a first joining flow path and a second joining flow path join, and thus it is possible to accurately detect a refrigerant state when a refrigerant flows only in the first joining flow path, when a refrigerant flows only in the second joining flow path, and when refrigerants flow in both the first joining flow path and the second joining flow path.

Although the present invention has been described above with reference to specific embodiments thereof, it will be understood by those skilled in the art that various modifications and changes may be made to the present invention without departing from the gist and scope of the present invention as set forth in the claims below.

What is claimed is:

1. A refrigerant circulating apparatus for a vehicle, comprising:
a refrigerant distribution unit in which a flow path through which a refrigerant flows is formed;
one or more heat exchangers that are coupled to one surface of the refrigerant distribution unit and perform heat exchange with the refrigerant; and
one or more valves that are coupled to the one surface of the refrigerant distribution unit and allow the refrigerant to selectively flow,
wherein a refrigerant inlet/outlet through which the refrigerant is introduced or discharged is formed in the other surface of the refrigerant distribution unit.

2. The refrigerant circulating apparatus of claim 1, wherein the refrigerant inlet/outlet is provided with a pipe flange for coupling of a pipe.

3. The refrigerant circulating apparatus of claim 1, wherein a controller that controls the valves is mounted on an upper portion of the refrigerant distribution unit in a direction perpendicular to the refrigerant distribution unit.

4. The refrigerant circulating apparatus of claim 1, wherein the heat exchanger and the valves are disposed to face a vehicle body, and the refrigerant inlet/outlet is disposed to face a power room.

5. The refrigerant circulating apparatus of claim 3, wherein a mounting wing for mounting the controller on the refrigerant distribution unit is provided on a side surface of the controller.

6. The refrigerant circulating apparatus of claim 3, further comprising one or more mounting brackets for mounting the refrigerant distribution unit on a vehicle body.

7. The refrigerant circulating apparatus of claim 6, wherein some of the mounting brackets have one end portion coupled to the vehicle body, and the other end portion coupled to both the refrigerant distribution unit and the controller.

8. The refrigerant circulating apparatus of claim 3, wherein a main connector is provided on a front surface of the controller that faces a vehicle body, and a wire unit electrically connected to the valves is connected to the main connector.

9. The refrigerant circulating apparatus of claim 3, wherein a sub-connector for electrical connection to an external power room component is provided on a side surface of the controller.

10. The refrigerant circulating apparatus of claim 3, wherein a wire unit electrically connected to the valves is connected to the controller, and the wire unit is disposed on the one surface of the refrigerant distribution unit to which the heat exchanger and the valve are coupled.

11. The refrigerant circulating apparatus of claim 1, wherein a PT sensor that detects a pressure or temperature of the refrigerant is coupled to the one surface of the refrigerant distribution unit.

12. A refrigerant circulating apparatus for a vehicle, comprising:
a refrigerant distribution unit in which a plurality of flow paths through which a refrigerant flows are formed; and
a PT sensor coupled to the refrigerant distribution unit and disposed downstream or at a point at which two or more flow paths join to detect a pressure or temperature of the refrigerant.

13. The refrigerant circulating apparatus of claim 12, wherein the PT sensor is disposed at a point at which a first joining flow path and a second joining flow path formed in the refrigerant distribution unit join.

14. The refrigerant circulating apparatus of claim 13, wherein the first joining flow path and the second joining flow path are disposed on a flow path through which a low-temperature refrigerant flows.

15. The refrigerant circulating apparatus of claim 13, wherein the first joining flow path is a flow path through which a refrigerant heat-exchanged in a heat exchanger flows, the second joining flow path is a flow path through which a refrigerant heat-exchanged in an evaporator flows, and the refrigerant joined in the first joining flow path and the second joining flow path flows to an accumulator.

16. The refrigerant circulating apparatus of claim 13, wherein, in a battery cooling mode, the refrigerant flows only in the first joining flow path.

17. The refrigerant circulating apparatus of claim 13, wherein, in a cooling or heating and dehumidification mode, the refrigerant flows only in the second joining flow path.

18. The refrigerant circulating apparatus of claim 13, wherein, in a cooling and battery cooling mode, the refrigerant flows in the first joining flow path and the second joining flow path.

19. The refrigerant circulating apparatus of claim 12, further comprising:
one or more heat exchangers that are coupled to one surface of the refrigerant distribution unit and perform heat exchange with the refrigerant; and
one or more valves that are coupled to the one surface of the refrigerant distribution unit and allow the refrigerant to selectively flow,
wherein a refrigerant inlet/outlet through which the refrigerant is introduced or discharged is formed in the other surface of the refrigerant distribution unit.

20. The refrigerant circulating apparatus of claim 19, wherein the PT sensor is coupled to the one surface of the refrigerant distribution unit to which the heat exchanger and the valve are coupled.
